(19) United States
(12) Patent Application Publication
(10) Pub. No.: US 2006/0049774 A1
(43) Pub. Date: Mar. 9, 2006

(54) Peak detecting circuit and discharge lamp lighting device

(76) Inventors: Tomoyuki Ichikawa, Shizuoka (JP); Shinji Ohta, Shizuoka (JP)

Correspondence Address: FISH & RICHARDSON P.C., P.O. BOX 1022, MINNEAPOLIS, MN, 55440-1022, US

(21) Appl. No.: 11/212,552

(22) Filed: Aug. 25, 2005

(30) Foreign Application Priority Data
Sep. 3, 2004 (JP) P. 2004-257068

(51) Int. Cl. H05B 37/02

(52) U.S. Cl. 315/209 R

(57) ABSTRACT

A peak detecting circuit 1 comprises an operational amplifier 2, a plurality of transistors 3 and 4 to be operated upon receipt of an output signal, and a holding capacitor 5. The transistors 3 and 4 are used as emitter followers or source followers, and the output signal of the transistor 3 is input to the operational amplifier 2 to obtain a negative feedback and the output signal of the transistor 3 is supplied to the capacitor 5. Moreover, a discharging resistor is provided in parallel with the capacitor 5 to intentionally provide a droop. Consequently, it is possible to follow a variation in the peak of an input signal which is changed momentarily.

### TECHNICAL FIELD

The present disclosure relates to a technique for enhancing precision in detection in a peak detecting circuit suitable for an increase in frequency, and a discharge lamp lighting device using the peak detecting circuit.

### BACKGROUND

A known peak detecting circuit for detecting various signals includes a peak hold circuit with a discharge buffer using an operational amplifier (a) and a diode (b), and a holding capacitor (c) as shown in FIG. 5, for example. More specifically, an input signal (referred to as “Vin”) is supplied to the non-inverted input terminal of the operational amplifier (a) The output signal of the operational amplifier (a) is supplied to the capacitor (c) through the diode (b) in a forward direction, and is supplied to the inverted input terminal of the operational amplifier (a).

The conventional circuit structure may encounter a problem of low precision when the peak of a high frequency signal is to be detected.

For example, in the circuit shown in FIG. 5, a peak can be determined with high precision within a range in which a low frequency signal of approximately several tens kilohertz or less is handled. Precision in detection may be deteriorated due to the delay of the operational amplifier in a high frequency area which is equal to or higher than the frequency (for example, 100 kHz or more).

Therefore, it is necessary to use a high-speed operational amplifier. However, typically only a region of approximately 200 to 300 kHz can be supported. It is hard to support frequencies on the order of a megahertz.

Referring to the upper limit of the frequency of the peak hold circuit, the reason why the speed increasing property of the operational amplifier is required is that the output of the operational amplifier is maintained in a saturation state on a negative side for a period of time other than a peak. A long time is taken because of a large potential difference until a predetermined output voltage (a voltage value of “Vout+V_{F}” which will be described below) is reached after the detection of the peak Therefore, a holding capacitor is to be charged. In other words, referring to the characteristic of the operational amplifier, a considerable speed increasing property is required for the frequency of an input signal (a source signal)

FIG. 6 is a schematic waveform diagram illustrating a relationship among the input signal “Vin”, an output signal “Vop” of the operational amplifier (a), and a peak hold output signal “Vout”, (A) showing the case of a low frequency and (B) showing the case of a high frequency.

In the first case (A), the value Vop is set in a saturation state in a negative direction when the input signal Vin indicates a portion other than the vicinity of a peak value, and “Vop” indicates a pulse-like voltage having a small width in the vicinity of the peak value. “V_{F}” indicates a voltage drop in a forward direction of the diode (b), and “Vout” indicates a level decreased from the peak value of Vop by the voltage V_{F} and is coincident with the peak value of Vin.

Also in the second case (B), the voltage Vop is set in the saturation state in the negative direction when the input signal Vin indicates a portion other than the vicinity of the peak value, and the voltage Vop rises with a delay time “τ” with respect to a rise to the peak value of the input signal (Vin). In that case, a sharp rising characteristic is required. In the case in which a high through rate is not guaranteed, the voltage (Vop) cannot follow a change in the input signal Vin. Vout indicates a level decreased from the voltage Vop by an amount V_{F} in a lower position than the peak value of Vin so that a detection error represented by “τ” is made.

Therefore, it would be desirable to detect the peak of a high frequency signal with high precision.

### SUMMARY

The disclosure provides a peak detecting circuit including an operational amplifier, transistors to be operated upon receipt of an output signal, and a holding capacitor. The transistors are used as emitter followers or source followers. An output signal of a first transistor serves as an input to the operational amplifier to obtain a negative feedback, and an output signal of a second transistor is supplied to the capacitor.

Moreover, the disclosure provides a discharge lamp lighting device including a dc/ac converting unit for carrying out ac conversion upon receipt of a dc input voltage, and a circuit for detecting a lamp voltage or a lamp current which is related to a discharge lamp. The detecting circuit includes an operational amplifier, transistors to be operated upon receipt of an output signal, a holding capacitor, and a resistor connected in parallel with the capacitor. The transistors are used as emitter followers or source followers. An output signal of a first transistor serves as an input to the operational amplifier to obtain a negative feedback, and an output signal of a second transistor is supplied to the capacitor.

The first transistor may be used for a feedback, and the second transistor may be used for charging the capacitor. The output of the operational amplifier is not saturated, but is caused to swing at the same frequency as the frequency of an input signal. Moreover, the first and second transistors can serve as the emitter followers or the source followers to support an increase in a frequency.

One or more advantages may be present in various implementations. For example, it is possible to accurately detect a peak with respect to a high frequency signal up to the frequency band of the operational amplifier.

An NPN transistor may be used for the first and second transistors, and the base of each of the transistors may be connected to the output terminal of the operational amplifier. In that case, the output of the emitter of the first transistor is supplied to the inverted input terminal of the operational amplifier, and the emitter of the second transistor is connected to the capacitor and the capacitor is grounded so that an effective circuit for the peak hold of a high frequency signal can be obtained.

If the discharging resistor is connected in parallel with the capacitor, it is possible to grasp a variation in the peak of the input signal which is changed momentarily by giving an intentional droop with a time constant determined from the resistance value of the discharging resistor and the electrostatic capacitance of the capacitance.

A first resistor may be connected to the emitter of the first transistor and a second resistor for charging may be connected in parallel with the capacitor to specify the resistance values of the first and second resistors to be equal to each other. Thus, it is possible to enhance precision in detection by causing a uniform load current to flow to the first and second transistors.

In the case in which the invention is applied to a circuit for detecting a lamp voltage or a lamp current which is related to a discharge lamp, an effective countermeasure can be taken to control lighting and to protect the circuit based on the accurate result of detection.

### BRIEF DESCRIPTION OF THE DRAWINGS

FIG. 1 is a diagram showing an example of a basic structure according to the invention.

FIG. 2 is a diagram showing an example of a circuit structure according to the invention.

FIG. 3 is a waveform diagram for explaining an operation in FIG. 2.

FIG. 4 is a diagram showing an example of an application to the detection of a lamp voltage in a discharge lamp lighting device.

FIG. 5 is a circuit diagram showing a conventional example of a structure.

FIG. 6 is a diagram for explaining possible problems is the conventional circuit.

### BEST MODE FOR CARRYING OUT THE INVENTION

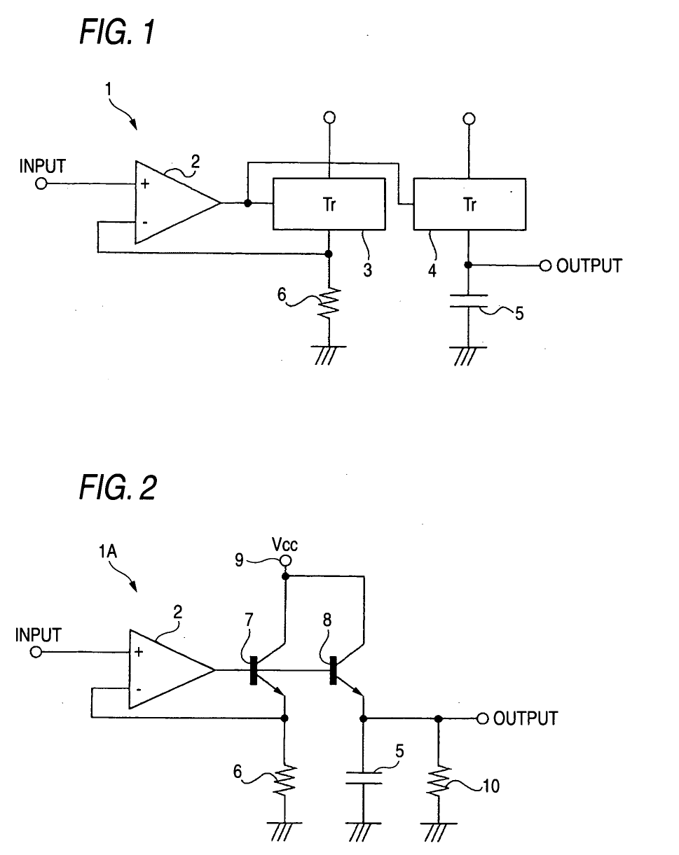

FIG. 1 is a diagram showing an example of the basic structure of a peak detecting circuit according to the invention.

A peak detecting circuit 1 includes an operational amplifier 2, transistors 3 and 4 to be operated upon receipt of the output signal of the operational amplifier 2, and a holding capacitor 5.

An input signal is supplied to the non-inverted input terminal of the operational amplifier 2, and the output signal of the operational amplifier 2 is supplied to the control terminals (bases and gates) of the transistors 3 and 4. A bipolar transistor or a unipolar transistor may be used for each of the transistors and is utilized as an emitter follower or a source follower.

A resistor 6 is connected to the non-control terminal of the transistor 3 and the output signal of the transistor 3 is supplied to the inverted input terminal of the operational amplifier 2 so that a negative feedback loop is formed.

The capacitor 5 is connected to the non-control terminal of the transistor 4. In some cases, a discharging resistor may be connected in parallel with the capacitor 5, as will be described below.

In the illustrated example, the transistor 3 and the transistor 4 are allocated to a feedback and the charge of the capacitor 5 respectively, and the output of the operational amplifier 2 is not saturated, but is caused to swing at the same frequency as the frequency of the input signal. Consequently, it is possible to follow a source signal up to the frequency band of the operational amplifier 2.

If a signal having a reverse phase to an input signal to be a detecting object is provided as an input to the operational amplifier 2, it is possible to carry out the detection of a bottom (which is substantially the same as the detection of a peak)

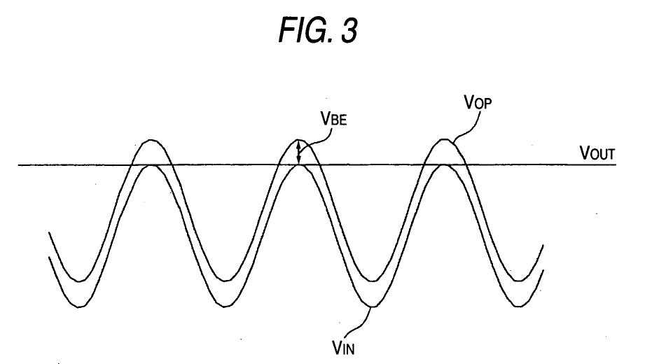

FIG. 2 shows a structural example 1A in which a bipolar transistor is used as the transistors 3 and 4.

In the example, NPN transistors 7 and 8 are used, and have their bases connected to the output terminal of the operational amplifier 2.

The collector of transistor 7 is connected to a power terminal 9 having a predetermined voltage “Vcc”, and the resistor 6 is connected to an emitter and is thus grounded. The output of the emitter is supplied to the inverted input terminal of the operational amplifier 2.

The collector of transistor 8 is connected to the power terminal 9 having the predetermined voltage “Vcc”. An emitter is connected to the capacitor 5 and the capacitor 5 is thus grounded. Furthermore, a resistor 10 is provided in parallel with the capacitor 5. The resistor 10 has a resistance value which is equal to that of the resistor 6.

A detection signal is obtained from an output terminal connected to the capacitor 5 and the resistor 10.

It is preferable that units having identical or almost identical characteristics should be used for the two transistors 7 and 8, and each of the transistors is operated as an emitter follower of a discharge type.

The output of the emitter of the transistor 7 is fed back to the inverted input terminal of the operational amplifier 2, and the transistor 7 is thus operated as a voltage follower of a discharge type. Assuming that an output voltage and an input voltage of the operational amplifier 2 are represented by “Vop” and “Vin”, respectively, and a voltage drop between the base and the emitter of the transistor 7 is represented by “V_{BE}”, a relationship of “Vop=Vin+V_{BE}” is obtained from “Vin=Vop−V_{BE}” by considering an imaginary short circuit in the operational amplifier 2.

The transistor 8 has its base connected to the output terminal of the operational amplifier 2 together with the base of the transistor 3 A voltage which is equal to a voltage applied to the resistor 6 is provided as an output to the capacitor 5 connected to the emitter of the transistor 8.

In the case in which the input signal of the operational amplifier 2 indicates the vicinity of a peak value, the emitter currents of the transistors become equal to each other when charging of the capacitor 5 is stopped (the resistors 6 and 10 have resistance values which are equal to each other).

If the characteristics of the transistors 7 and 8 are uniform, moreover, V_{BE} of each of the transistors has an equal value in the vicinity of the peak value of the input signal so that the peak of the input signal can be held in the capacitor 5 with high precision.

FIG. 3 is a schematic waveform diagram illustrating a relationship among Vin, Vop and a peak detection signal voltage “Vout”.

The output voltage (Vop) of the operational amplifier 2 swings with a higher level than the input voltage (Vin) by a value V_{BE} and the level of Vout indicates the peak value of Vin.

In the example, the charging resistor 10 is connected in parallel with the capacitor 5 to provide an intentional droop. In other words, the capacitor 5 is discharged through the resistor 10 and functions as a filter with a time constant determined by the product of the electrostatic capacitance of the capacitor 5 and the resistance value of the resistor 10. The terminal voltage of the capacitor 5 drops with the time constant when the peak value of the input signal is not detected. For example, the maximum level of the input signal is only detected in a simple peak hold. In the case in which it is necessary to detect a peak value which is changed momentarily, it is preferable to employ a circuit structure in which the discharging resistor 10 is connected in parallel with the capacitor 5 and the time constant is set to be equal to approximately a control reaction time (the value of the time constant is much greater than the cycle of the input signal).

In the implementation of a pure peak hold function, the resistor 10 is not required.

In the case in which the peak detecting circuit is applied to a circuit for detecting a lamp voltage or a lamp current in a discharge lamp lighting device, for example, the following configurations can be employed.
(1) A configuration for specifying a high frequency taking the shape of a sine wave on the order of megahertz and detecting the lamp current or lamp voltage of a discharge lamp to control a power to be supplied to the discharge lamp in order to avoid the acoustic resonance of a discharge tube in the case in which an HID lamp is to be driven at the same frequency, and
(2) A configuration for deciding a load state based on the detected value of the lamp voltage or lamp current as a countermeasure to be taken when the load abnormality of the discharge lamp is generated.

In the first case (1), for example, the peak of the lamp voltage or lamp current taking the shape of a sine wave at a high frequency is detected, and the power to be supplied to the discharge lamp is calculated based on the result of the detection to enhance the accuracy of detection of the lamp voltage corresponding to high frequency driving.

The second case (2) can help protect the circuit by correctly determining an abnormality. For example, if it is determined that an accident occurred on a load state based on the peak detecting circuit to detect the lamp voltage or the lamp current, the supply of the power to the discharge lamp can be immediately blocked or an alarm display can be generated. Consequently, it is possible to fully take safety measures, for example, to prevent an ignition or to protect the circuit.

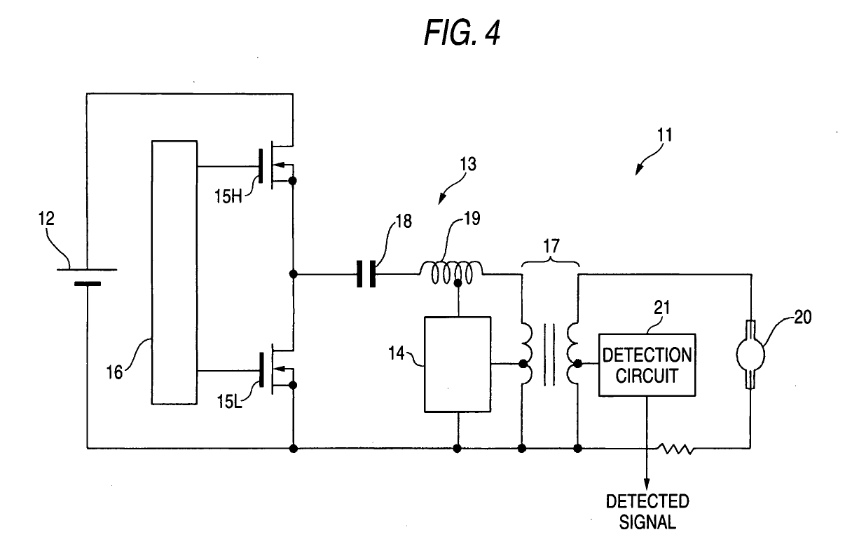

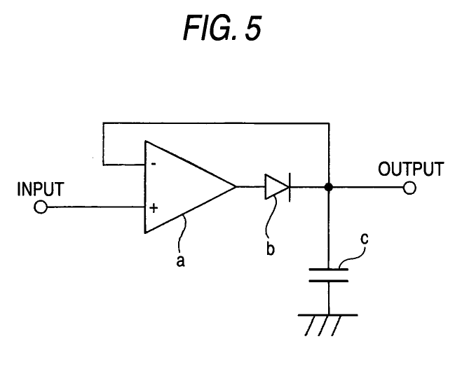

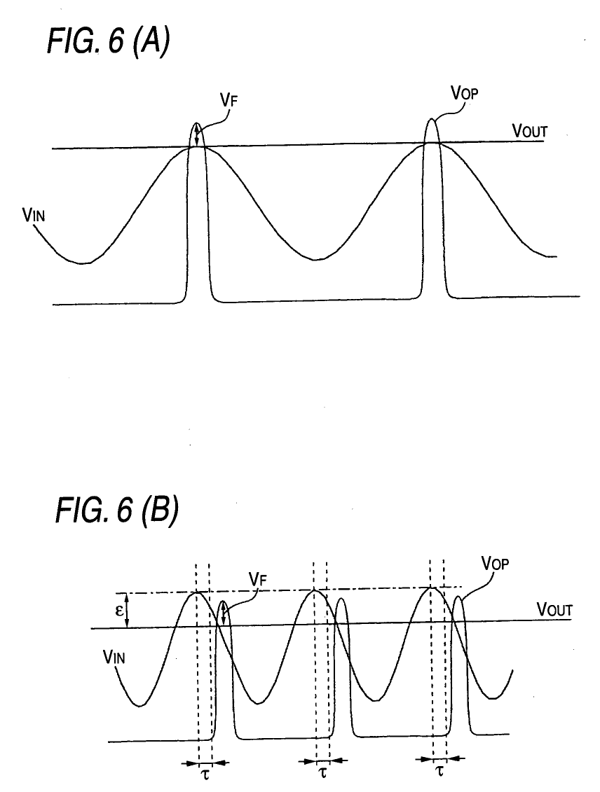

FIG. 4 shows an example of a discharge lamp lighting device 11 (an HID lamp lighting circuit through high frequency lighting) which includes a dc/ac converting unit 13 for receiving the supply of a power from a dc power supply 12, and a starting circuit 14.

The dc/ac converting unit 13 is provided for carrying out an ac conversion and raising a voltage upon receipt of a dc input voltage from the dc power supply 12. In the example, a half bridge type is employed and includes switching units 15H and 15L (an FET is used in the example) and a gate driving unit 16 for controlling their driving operations. The unit 15H on a high stage side has one of its terminals connected to a terminal on the positive electrode side of the dc power supply 12 and has the other terminal grounded through the unit 15L on a lower stage side, and the units 15H and 15L are alternately subjected to a switching control at an interval of a predetermined stop period.

In the example, the circuit structure has a transformer 17 for power conversion and utilizes the resonance phenomenon of a capacitor 18 and inductor 19.

The starting circuit 14 is provided for supplying a starting signal to a discharge lamp 20. An output voltage at time of starting is raised by the transformer 17 and is thus applied to the discharge lamp 20 (the starting signal is superposed on an ac converted output and is supplied to the discharge lamp 20).

A detecting circuit 21 provided on the secondary side of the transformer 17 includes the circuit 1A and a limiter in order to detect the lamp voltage of the discharge lamp 20. The input terminal of the detecting circuit 21 is connected to the middle of the secondary winding of the transformer 17, and a detection signal is sent to a control circuit and a protecting circuit (which are not shown). To detect a signal which follows a change in the lamp voltage, RC filters (the capacitor 5 and the resistor 10) mat be used in the peak detecting circuit and set a frequency required for a calculation related to the supply of a power to the discharge lamp 20 (which is assumed to have a sufficiently smaller value than a lighting frequency).

The invention is not restricted to the particular examples above. The circuit 1A can be used in the circuit for detecting the lamp current. Although FIG. 4 shows the structure of the half bridge type which uses the units 15H and 15L, it is also possible to employ a structure of a full bridge type using four switching units. For example, a dc input voltage may be converted into a desirable level and may be converted into an ac output by a power inverter (a so-called inverter) so as to be supplied to a discharge lamp.

What is claimed is:

1. A peak detecting circuit comprising an operational amplifier, a plurality of transistors to be operated upon receipt of an output signal, and a holding capacitor,
wherein the transistors are configured as emitter followers or source followers and wherein, during operation, an output signal of a first transistor serves as an input to the operational amplifier to obtain a negative feedback, and an output signal of a second transistor is supplied to the capacitor.

2. The peak detecting circuit according to claim 1, wherein NPN transistors are used as the transistors, and a base of each of NPN transistor is connected to an output terminal of the operational amplifier, and
an output of an emitter of the first transistor is supplied to an inverted input terminal of the operational amplifier, and an emitter of the second transistor is connected to the capacitor,which is grounded.

3. The peak detecting circuit according to claim 1, wherein a discharging resistor is connected in parallel with the capacitor.

4. The peak detecting circuit according to claim 2, wherein a first resistor is connected to the emitter of the first transistor, a second resistor for discharge is connected in parallel with the capacitor, and resistance values of the first and second resistors are substantially equal to each other.

5. A discharge lamp lighting device comprising a dc/ac converting unit for carrying out an ac conversion upon receipt of a dc input voltage and a circuit for detecting a lamp voltage or a lamp current which is related to a discharge lamp,
wherein the detecting circuit includes an operational amplifier, a plurality of transistors to be operated upon receipt of an output signal, a holding capacitor, and a resistor connected in parallel with the capacitor, and
the transistors are configured as emitter followers or source followers, an output signal of a first transistor serves as an input to the operational amplifier to obtain a negative feedback, and an output signal of a second transistor is supplied to the capacitor.
